(19) United States
(12) Patent Application Publication
(10) Pub. No.: US 2007/0228972 A1
(43) Pub. Date: Oct. 4, 2007

(54) Plasma display panel

(75) Inventor: Kyu-Hang Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/690,970

(22) Filed: Mar. 26, 2007

(30) Foreign Application Priority Data
Mar. 29, 2006 (KR) 2006-28400

(51) Int. Cl. H01J 17/49

(52) U.S. Cl. 313/584; 313/582

(57) ABSTRACT

A plasma display panel (PDP) to improve bright room contrast and emission efficiency. The PDP includes first and second substrates facing each other; a barrier ribs, which define a plurality of discharge cells and include a plurality of protrusion units protruding into the discharge cells; fluorescent layers formed in the discharge cells; X and Y electrodes which respectively include extension units extending across the first substrate and discharge units protruding from the extension units toward the center of each of the discharge cells; X and Y bus electrodes disposed parallel to and contacting the X and Y electrodes; and a plurality of address electrodes extending across the second substrate to cross the pairs of electrodes and the pairs of bus electrodes.

### CROSS-REFERENCE TO RELATED APPLICATIONS

This application claims the benefit of Korean Patent Application No. 2006-28400, filed Mar. 29, 2006, in the Korean Intellectual Property Office, the disclosure of which is incorporated herein by reference.

### BACKGROUND OF THE INVENTION

1. Field of the Invention

Aspects of the present invention relate to a plasma display panel (PDP), and more particularly, to a PDP having improved bright room contrast and increased emission efficiency.

2. Description of the Related Art

Plasma display panels (PDPs) operate by applying a discharge voltage to a discharge gas filled in a sealed structure of two substrates. A plurality of electrodes is formed between the substrates and desired images are displayed using ultraviolet rays generated due to a gas discharge. PDPs have generally come to be regarded as replacements for conventional cathode ray tube (CRT) display devices.

A PDP includes first and second substrates facing each other with a predetermined space therebetween, a plurality of barrier ribs defining a plurality of discharge cells, a discharge gas filling and discharging in the discharge cells, fluorescent layers formed on the surfaces of the discharge cells and a plurality of electrodes to which a voltage is applied to discharging discharge in the discharge cells.

Research has recently been conducted on PDPs having high definition and high contrast. In particular, as demand for full high definition (FHD) PDPs increases, research to improve the definition of PDPs is being actively conducted. Definition of PDPs is determined by luminance, color temperature, bright room contrast, false contour and the like. Among these characteristics, bright room contrast needs to be increased to realize clear images. This can be achieved by reducing background light of a PDP, increasing emission of discharge cells, or reducing reflection of external light.

Conventionally, black stripes are used for improving bright room contrast. Black stripes are formed on a front substrate of a PDP to correspond to barrier ribs. The black stripes reduce reflection luminance of external light by absorbing light incident from the outside. However, when using black stripes, an additional process of patterning black stripes is required and black stripes are disposed on a front substrate at the same time as electrodes are formed such that changing electrode positions is limited.

Korean Patent Publication Gazette No. 528919 discloses a PDP using complementary colors. In the PDP disclosed in the above publication, reflection luminance is reduced by forming a front dielectric layer formed on a front substrate to cover electrodes and barrier ribs disposed on a back substrate with a pair of complementary colors.

In a PDP using complementary colors, the width of barrier ribs is a key element to determine reflection luminance of external light. The rate of decrease of the reflection luminance of external light is proportional to the rate of increase of a black portion of the entire region of the PDP. The rate of increase of the black portion is affected by the width of the bus electrodes and the width of the barrier ribs. Accordingly, the width of the barrier ribs is increased to reduce the reflection luminance of external light. However, as the width of the barrier ribs increases, discharge space is reduced, thereby reducing internal luminance.

### SUMMARY OF THE INVENTION

According to aspects of the present invention, there is provided is a plasma display panel (PDP) having improved bright room contrast and increased emission efficiency.

According to an aspect of the present invention, there is provided a PDP including a first substrate; a second substrate which faces the first substrate, with a predetermined space therebetween; a plurality of barrier ribs which define a plurality of discharge cells and include a plurality of protrusion units protruding into the discharge cells; a plurality of fluorescent layers formed in the discharge cells; a plurality of pairs of electrodes including pluralities of X and Y electrodes, which respectively include a plurality of extension units extending across the first substrate and a plurality of discharge units protruding from the extension units toward the center of each of the discharge cells; a plurality of pairs of bus electrodes including pluralities of X and Y bus electrodes extending to cross the first substrate, disposed parallel to the electrodes and contacting the electrodes; and a plurality of address electrodes extending across the second substrate to cross the pairs of electrodes and the pairs of bus electrodes. The protrusion units of the barrier ribs are formed to correspond to a shape of the discharge units of the electrodes such that an interval between the barrier ribs and the discharge units of the electrodes is formed to have a predetermined range.

The discharge units of the electrodes may include first discharge units which protrude from the extension units toward the center of the discharge cells; and second discharge units which protrude from the first discharge units toward the center of the discharge cells and have a width greater than the first discharge units.

The barrier ribs may include transverse barrier ribs formed in a widthwise direction of the PDP; and longitudinal barrier ribs formed in a lengthwise direction of the PDP.

The protrusion units of the barrier ribs may include first protrusion units which protrude from both sidewalls of the barrier ribs to correspond to the first discharge units of the X electrodes; and second protrusion units which protrude from both sidewalls of the barrier ribs to correspond to the first discharge units of the Y electrodes. Here, the interval between the first discharge units and the barrier ribs may be 60 to 80 μm and the interval between the second discharge units and the barrier ribs may be 60 to 80 μm.

According to another aspect of the invention, a plasma display panel is provided, including: a first substrate; a second substrate which faces the first substrate; barrier ribs disposed between the first and second substrates that define discharge cells; and pairs of electrodes comprising extension units to extend across the first substrate and discharge units to extend from the extension units toward the center of each of the discharge cells, wherein the discharge units are formed to correspond to the edges of the discharge cells as defined by the barrier ribs and are set apart therefrom by a predetermined distance. The plasma display panel may further contain barrier ribs that include protrusion units to extend from the barrier ribs into the discharge cells.

According to another aspect of the invention, a plasma display panel is provided, including: a first substrate; a second substrate which faces the first substrate; barrier ribs disposed between the first and second substrates that define discharge cells and comprise protrusion units protruding into the discharge cells; and pairs of electrodes comprising extension units to extend across the first substrate and discharge units to extend from the extension units toward the center of each of the discharge cells, wherein the protrusion units of the barrier ribs increase the internal surface area of the discharge cells.

According to another aspect of the invention, a plasma display panel is provided, including: a first substrate; a second substrate which faces the first substrate; barrier ribs disposed between the first and second substrates that define discharge cells; and pairs of electrodes comprising extension units to extend across the first substrate and discharge units to extend from the extension units toward the center of each of the discharge cells.

As described above, the ratio of a black portion to the entire region may be increased and bright room contrast may be improved by forming protrusion units on barrier ribs corresponding to a shape of discharge units of electrodes. Furthermore, emission efficiency may be improved due to the increased area of fluorescent layers and strong discharge occurring in the vicinity of the electrodes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic exploded perspective view of a plasma display panel (PDP) according to aspects of the present invention; and

FIG. 2 illustrates an arrangement structure of barrier ribs and electrodes of the PDP in FIG. 1, according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

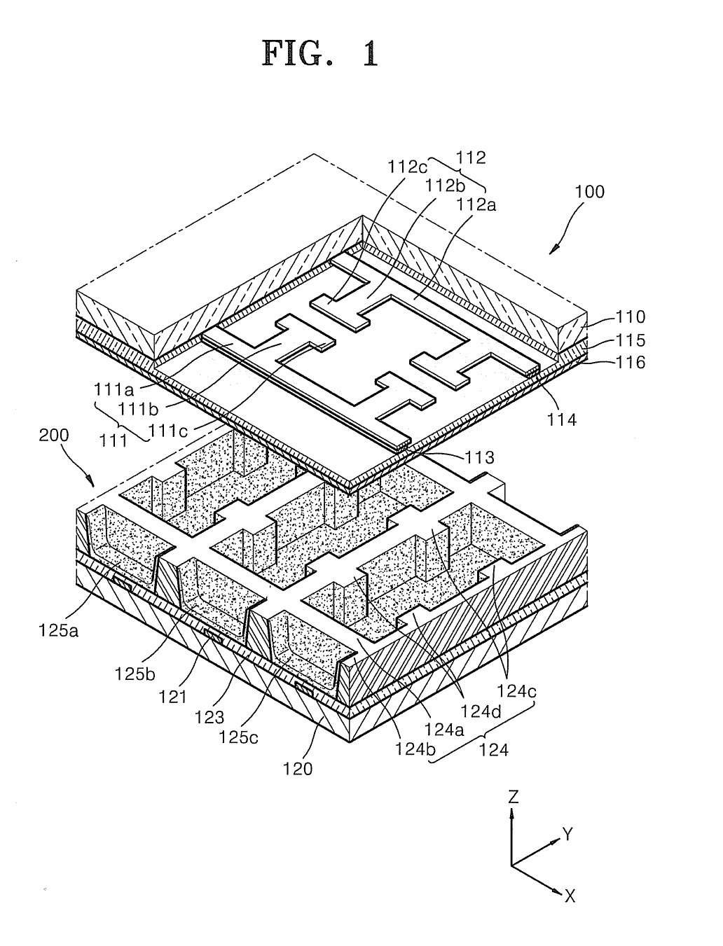

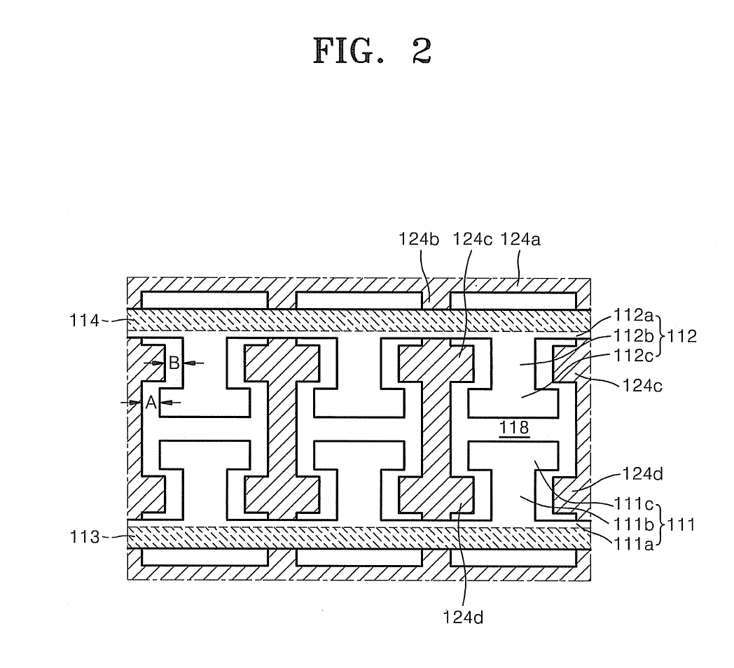

FIG. 1 is an exploded perspective view of a plasma display panel (PDP) according to aspects of the present invention. FIG. 2 illustrates an arrangement structure of barrier ribs and electrodes of the PDP in FIG. 1, according to aspects of the present invention.

Referring to FIGS. 1 and 2, the PDP includes front and back panels 100 and 200. A first substrate 110 of the front panel 100 is disposed to face a second substrate 120 of the back panel 200, with a predetermined space therebetween. A plurality of pairs of sustain electrodes 111 and 112 upon which a plurality of pairs of bus electrodes 113 and 114 are respectively disposed are formed on the bottom of the first substrate 110 or, another way, are formed on a side of the first substrate 110 that faces the second substrate 120 so that the sustain electrodes 111 and 112 are disposed between the first and second substrates 110 and 120, respectively. The plurality of pairs of sustain electrodes 111 and 112 are formed of a transparent, conductive material, such as indium tin oxide (ITO). The pairs of sustain electrodes 111 and 112 and bus electrodes 113 and 114 extend across the first substrate 110. A first dielectric layer 115 is formed on the first substrate 110 to cover the pairs of sustain electrodes 111 and 112 and bus electrodes 113 and 114. A protection layer 116 is formed on the first dielectric layer 115.

A plurality of address electrodes 121, which are formed on the second substrate 120, extend across the second substrate 120 to cross the pairs of sustain electrodes 111 and 112 and bus electrodes 113 and 114. A second dielectric layer 123 is formed on the second substrate 120 to cover the address electrodes 121. A plurality of barrier ribs 124 are formed between the first and second substrates 110 and 120 to partition discharge space and define a plurality of discharge cells 118. A plurality of fluorescent layers 125a, 125b and 125c are formed in the discharge cells 118.

More specifically, discharge space is formed by the first and second substrates 110 and 120 which are disposed to face each other. The first substrate 110 is formed of a transparent glass to transmit visible light. However, the present invention is not limited thereto. The second substrate 120 can also be formed of a transparent material. In this case, a transmission type PDP, in which vacuum-ultraviolet rays generated from an excited discharge gas excite the fluorescent layers 125a, 125b and 125c and visible light generated from the fluorescent layers 125a, 125b and 125c is transmitted through the second substrate 120, is also within the scope of the present invention.

The pairs of sustain electrodes 111 and 112 and bus electrodes 113 and 114 are formed parallel to each other on the first substrate 110 of the front panel 100. Each pair of sustain electrodes 111 and 112 includes an X electrode and a Y electrode, wherein either of the sustain electrodes 111 and 112 may act as the X electrode or the Y electrode. The sustain electrodes 111 and 112 extend in a transverse direction crossing a direction in which the address electrodes 121 extend—the X direction of FIG. 1. The sustain electrodes 111 and 112 may cross the address electrodes 121 perpendicularly. The sustain electrodes are formed of a transparent conductive material such as indium-tin-oxide (ITO) to transmit visible light.

The sustain electrodes 111 and 112 include extension units 111a and 112a which extend to cross the PDP. In FIG. 1, the sustain electrodes 111 and 112 extend in the X direction via the extension units 111a and 112a. The sustain electrodes 111 and 112 respectively include first discharge units 111b and 112b and second discharge units 112c and 112b which protrude from the extension units 111a and 112a toward the center of each of the discharge cells 118 coplanarly. The first discharge units 111b and 112b extend from the extension units 111a and 112a toward the center of the discharge cells 118, and the second discharge units 111c and 112c further extend from the first discharge units 111b and 112b toward the center of the discharge cells 118. The width of the second discharge units 111c and 112c is greater than the width of the first discharge units 111b and 112b. However, the shape of the extension units 111a and 112a, the first discharge units 111b and 112b, and the second discharge units 111c and 112c are not limited thereto such that the shape thereformed may trace the shape of the discharge cells 118 or be polygonal, circular, or ellipsoid extensions from the sustain electrodes 111 and 112.

The total area of sustain electrodes 111 and 112 in the PDP is smaller than the total area of the sustain electrodes in a conventional PDP. This is because the first discharge units 111b and 112b of the sustain electrodes 111 and 112 in the PDP have a smaller width than discharge units of the conventional PDP. As the area of the sustain electrodes 111 and 112 is decreased, power consumption is decreased and electrical efficiency is increased.

Barrier ribs 124 are disposed between the first and second substrates and partition discharge space into a plurality of the discharge cells 118. The barrier ribs 124 prevent crosstalk between the discharge cells 118. The barrier ribs 124 are formed in the shape of a matrix including transverse barrier ribs 124a and the longitudinal barrier ribs 124b, as illustrated in FIGS. 1 and 2.

The barrier ribs 124 further comprise first protrusion units 124c and second protrusion units 124d, which protrude into the discharge cells 118. Specifically, the first and second protrusion units 124c and 124d protrude from adjacent longitudinal barrier ribs 124b into the discharge cells 118, and more specifically, from the left and right sidewalls of the longitudinal barrier ribs 124b into the discharge cells 118. The first protrusion units 124c protrude from the left and right sidewalls of the longitudinal barrier ribs 124b to correspond to the sustain electrodes 112, and second protrusion units 124d protrude from the left and right sidewalls of the longitudinal barrier ribs 124b to the sustain electrodes 111. The horizontal cross sections of the first and second protrusion units 124c and 124d, viewed in a direction from the first substrate 110 to the second substrate 120, may be substantially rectangular. However, the first and second protrusion units 124c and 124d are not limited thereto such that the first and second protrusion units 124c and 124d may have a substantially triangular, polygonal, circular, or semicircular shape, when viewed in a direction from the first substrate 110 to the second substrate 120.

Referring to FIG. 2, the distance B is the length of the distance between the first discharge units 111b and 112b and the second and first protrusion units 124d and 124c, respectively, of adjacent longitudinal barrier ribs 124b of the barrier ribs 124. The distance B may be about 60 to 80 μm. The width of the first discharge units 111b and 112b is determined by the distance B between the first discharge units 111b and 112b and the second and first protrusion units 124d and 124c, respectively, of the longitudinal barrier ribs 124b and the distance between the first and second protrusion units 124c and 124d of the adjacent longitudinal barrier ribs 124b. Thus, the sum of the width of one of the first discharge units 111b and 112b and two times the distance B equals the distance between the second and first protrusion units 124d and 124c, respectively. The first discharge units 111b and 112b are each separated from the second and first protrusion units 124d and 124c, respectively, of the adjacent longitudinal barrier ribs 124b by the distance B. Similarly, the distance A between the second discharge units 111c and 112c and the adjacent longitudinal barrier ribs 124b may be 60 to 80 μm. The width of the second discharge units 111c and 112c is determined by the distance A between the second discharge units 111c and 112c and the longitudinal barrier ribs 124b and the distance between the adjacent longitudinal barrier ribs 124b. Thus, the distance between the adjacent longitudinal barrier ribs 124b equals the sum of the width of one of the second discharge units 111c and 112c and two times the distance A. The second discharge units 111c and 112c are each separated from the adjacent longitudinal barrier ribs 124b by the distance A.

Strong discharge may occur in the vicinity of the discharge units 111b, 111c, 112b, and 112c of the sustain electrodes 111 and 112. Such strong discharge results from the fluorescent layers 125a, 125b and 125c being formed thicker on the sidewalls of the longitudinal barrier ribs 124b than on the other portions of the internal surface of the discharge cell 118. The fluorescent layers 125a, 125b, and 125c are formed on the sidewalls of the longitudinal barrier ribs 124b to a thickness of about 30 to 50 μm. The amount of visible light converted from ultraviolet rays increases in a region where the thickness of the fluorescent layers 125a, 125b and 125c is greater relative to other regions. Specifically, sustain discharge occurs about the second discharge units 111c of the sustain electrodes 111 and the second discharge units 112c of the sustain electrodes 112. The sustain discharge diffuses to the first discharge units 111b of the sustain electrodes 111 and the first discharge units 112b of the sustain electrodes 112 during the sustain discharge. Strong discharge occurs in a discharge gap between the second discharge units 111c of the sustain electrodes 111 and the second discharge units 112c of the sustain electrodes 112, and in the vicinity of the first and second discharge units 111b, 112b, 111 c, and 112c of the sustain electrodes 111 and 112.

Luminance can be improved by disposing the thick portions of the fluorescent layers 125a, 125b and 125c in the vicinity of the first discharge units 111b and 112b, thereby increasing the amount of visible light converted from ultraviolet rays. Similarly, luminance can be improved by disposing the thick portions of the fluorescent layers 125a, 125b and 125c in the vicinity of the second discharge units 111c and 112c, thereby increasing the amount of visible light converted from ultraviolet rays.

Though not shown in the drawings, middle end portions of the second discharge units 112c of the sustain electrodes 112 and the second discharge units 111c of the sustain electrodes 111 can be respectively dented. Accordingly, a longer gap is formed between the middle end portions of the second discharge units 112c of the sustain electrodes 112 and the second discharge units 111c of the sustain electrodes 111, and a shorter gap is respectively formed between lateral end portions of the second discharge units 112c of the sustain electrodes 112 and the second discharge units 111c of the sustain electrodes 111. Since sustain discharge occurring at the shorter gap diffuses to the longer gap, thereby expanding discharge space, discharge efficiency is improved. The second discharge units 111c and 112c may have a chevron shape, or a curved shape so that wide end portions of the second discharge units 111c and 112c that extend wider than the first discharge units 111b and 112b are closer than middle end portions of the second discharge units 111c and 112c. However, the longer and shorter gaps may not be requisitely adopted in the PDP.

The barrier ribs 124 are colored with a complementary color of the first dielectric layer 115.

Complementary colors are pairs of colors which, when mixed, produce an achromatic color such as gray or black. Complementary colors cannot be defined exactly but generally opposite colors on a color wheel are pairs of complementary colors, for example, red and green or cyan, yellow and blue, and green and purple or magenta, depending upon the gradation of the color wheel.

According to an embodiment of the present invention, the first dielectric layer 115 may be colored with a color including blue, and the upper portions or the entire portions of the barrier ribs 124 may be colored with a color including brown. However, the present invention is not limited thereto. The first dielectric layer 115 and the barrier ribs 124 can be colored with other pairs of complementary colors as long as the upper portions of the barrier ribs 124 are colored with a reflective color to prevent reduction of internal luminance (occurring through absorption of light generated from the fluorescent layers 125a, 125b and 125c), and the first dielectric layer 115 is colored with a transmissive color to transmit light generated from the discharge cells 118. Either the upper portions or entire portions of the barrier ribs 124 can be colored.

The barrier ribs 124, which include the first and second protrusion units 124c and 124d, are colored with a complementary color with respect to the color of the first dielectric layer 115 and can be formed with a colored raw material to manufacture the barrier ribs 124, by conventional methods comprising screen printing, sandblasting, lift-off, photolithography, and etching.

The ratio of a black portion to the entire region is increased and reflection luminance of external light can be reduced by forming the barrier ribs 124 including the first and second protrusion units 124c and 124d as described above. Furthermore, emission efficiency is improved due to the increased area of the fluorescent layers 125a, 125b and 125c according to the increased surface area of the barrier ribs 124 resulting in the increased surface of the discharge cells 118.

The bus electrodes 113 and 114 are disposed parallel to the sustain electrodes 111 and 112 and contact the bottom of the extension units 111a and 112a of the sustain electrodes 111 and 112 so as to increase electrical conductivity of the sustain electrodes 111 and 112. Each pair of bus electrodes 113 and 114, similar to the sustain electrodes 111 and 112, may act as X and Y electrodes, which corresponds to the conventional art. The bus electrodes 113 and 114 are opaque metal electrodes having excellent electrical conductivity formed of opaque metals comprising Cr—Cu—Cr and Ag, or the like.

Pulse signals applied to the sustain electrodes 111 and 112 and the bus electrodes 113 and 114 are applied to the sustain electrodes 111 and 112 disposed in the discharge cells 118 through the bus electrodes 113 and 114. The width of the bus electrodes 113 and 114 has to be determined appropriately considering the manufacturing process, the width of the transverse barrier ribs 124a, the prevention of short circuits, and etc.

Referring to FIG. 2, the bus electrodes 113 and 114 are disposed closer to the center of the discharge cells 118 than the transverse barrier ribs 124a. In other words, the bus electrodes 113 and 114 are disposed above the extension units 111a and 112a between the transverse barrier ribs 124a and the second and first protrusion units 124d and 124c, respectively. Alternatively, the bus electrodes 113 and 114 can be formed in the discharge cells 118 while portions of the bus electrodes 113 and 114 overlap the transverse barrier ribs 124a.

Though not shown in FIG. 2, the bus electrodes 113 and 114 can be formed on the transverse barrier ribs 124a. This can be applied to a PDP having a double barrier-rib structure. A double barrier-rib structure is a structure having non-discharge cells in which discharge does not occur. Further, the double barrier-rib structure is a structure in which two parallel transverse barrier ribs are disposed above and below the discharge cells, respectively, extending in the direction of the address electrodes, thereby forming two sets each comprising two parallel transverse barrier-ribs above and below the discharge cell, respectively, wherein each of the two sets of the two parallel transverse barrier-ribs form a non-discharge cell. Consequently, the two non-discharge cells are formed above and below the discharge cell, respectively. In other words, two transverse barrier ribs 124a are formed in each of the discharge cells 118. Here, the non-discharge cells are much smaller than the discharge cells 118 such that the non-discharge cells cannot substantially affect resolution. In the PDP having a double barrier-rib structure, the bus electrodes 113 and 114 can be disposed on the transverse barrier ribs 124a. In other words, the bus electrodes 113 and 114 and extension units 111a and 112a of the sustain electrodes 111 and 112 are not disposed in the discharge space of the discharge cells 118. Furthermore, a minimum unit light (minimum amount of visible light for one sub-pixel) is reduced and power consumption is decreased by adopting a double barrier-rib structure in the PDP.

The first dielectric layer 115 is formed to cover the pairs of sustain electrodes 111 and 112 and bus electrodes 113 and 114 on the first substrate 110. The first dielectric layer 115 is an insulator and operates as a condenser during discharge. The first dielectric layer 115 restricts current flow and accumulates negative or positive charges to form a wall charge. Then, during a sustain period, only subpixels on which wall charges are formed can be turned on when the driving voltage is applied to the sustain electrodes 111 and 112 and the bus electrodes 113 and 114. When visible light generated from the discharge cells 118 is transmitted through the first substrate 110 and forms an image, the first dielectric layer 115 is formed of a material having excellent light transmittance. As described above, the first dielectric layer 115 can be colored of a complementary color with respect to the color of the barrier ribs 124. Accordingly, though black stripes are not disposed in portions corresponding to the barrier ribs 124, the ratio of a black portion to the entire region is increased and bright room contrast is improved.

The protection layer 116 is formed on the first dielectric layer 115. The protection layer 116 increases emissions of secondary electrons so as to facilitate discharge and prevent damage to the sustain electrodes 111 and 112 and the bus electrodes 113 and 114 by protecting the surface of the first dielectric layer 115. The protection layer 116 is formed of a material having high transmittance, high sputtering-resistance, low discharge voltage, large memory margin, driving voltage stability, and so on. For example, the protection layer 116 can be formed of MgO.

On the second substrate 120 of the back panel 200, a plurality of the address electrodes 121 extend across the PDP to cross the sustain electrodes 111 and 112 and the bus electrodes 113 and 114. The second dielectric layer 123 is formed on the second substrate 120 to cover the address electrodes 121. The second dielectric layer 123 performs similar functions as the first dielectric layer 115. When visible light generated from the discharge cells 118 is transmitted through the first substrate 110, the second dielectric layer 123 may be formed not of a transparent material but be formed of a reflective material to reflect the visible light to the first substrate 110. However, when visible light is transmitted through the second substrate 120, the second dielectric layer 123 is formed of a transparent material. The barrier ribs 124 are formed on the second dielectric layer 123 to partition discharge space into a plurality of the discharge cells 118.

The fluorescent layers 125a, 125b and 125c include red (R), green (G) and blue (B) fluorescent layers respectively, and are formed sequentially in each of the discharge cells 118. The fluorescent layers 125a, 125b and 125c can be formed on sidewalls and bottoms of the discharge cells 118, but are not limited thereto. When discharge is generated, a photoluminescence (PL) mechanism occurs. Photoluminescence is a mechanism in which vacuum-ultraviolet radiation generated by discharge excite electrons of the fluorescent layers 125a, 125b and 125c and the excited electrons emit visible light when returning to a stable state, that is, a low energy level.

The red (R) fluorescent layers 125a can be formed of Y_{0.66}Gd_{0.35}BO₃:Eu₃, Y₂O₃:Eu, GdBO₃:Eu or the like. The green (G) fluorescent layers 125b can be formed of Zn₂SiO₄:Mn, BaAl₁₂O₁₉:Mn, YBO₃:Tb or the like. The blue (B) fluorescent layers 125c can be formed of BaMgAl₁₀O₁₇:Eu²⁺ or the like.

When the first and second substrates 110 and 120 are attached to each other, the internal space of the PDP is filled with air. Accordingly, air in the PDP has to be completely exhausted and an appropriate discharge gas has to be injected into the internal space so as to improve discharge efficiency. A discharge gas such as Ne—Xe, He—Xe or He—Ne—Xe can be used in this regard.

During sustain discharge, an excited discharge gas generates ultraviolet rays while being stabilized, and the ultraviolet rays excite each of the R, G and B fluorescent layers 125a, 125b and 125c formed in the discharge cells 118. Accordingly, red, green and blue visible light generated by the excited fluorescent layers 125a, 125b and 125c is emitted from the discharge cells 118 respectively and defines a color to display in a pixel. A plurality of the pixels forms an image.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel comprising:
a first substrate;
a second substrate which faces the first substrate with a predetermined space therebetween;
a plurality of barrier ribs which define a plurality of discharge cells and comprise a plurality of protrusion units protruding into the discharge cells;
a plurality of fluorescent layers formed in the discharge cells;
a plurality of pairs of electrodes comprising pluralities of X and Y electrodes, wherein each electrode comprises a plurality of extension units extending across the first substrate and a plurality of discharge units protruding from the extension units toward the center of each of the discharge cells;
a plurality of pairs of bus electrodes comprising pluralities of X and Y bus electrodes extending across the first substrate, disposed parallel to the electrodes and contacting the electrodes; and
a plurality of address electrodes extending across the second substrate to cross the pairs of electrodes and the pairs of bus electrodes,
wherein the protrusion units of the barrier ribs are formed to correspond to a shape of the discharge units of the electrodes such that an interval between the barrier ribs and the discharge units of the electrodes is formed to have a predetermined range.

2. The plasma display panel of claim 1, further comprising:
a first dielectric layer formed on the first substrate to cover the pairs of electrodes and the pairs of bus electrodes;
a protection layer formed on the first dielectric layer; and
a second dielectric layer formed on the second substrate to cover the pairs of address electrodes,
wherein the barrier ribs are formed on the second dielectric layer.

3. The plasma display panel of claim 1, wherein the barrier ribs comprise transverse barrier ribs which extend in a direction perpendicular to an extending direction of the address electrodes and longitudinal barrier ribs which extend in a direction parallel to the address electrodes.

4. The plasma display panel of claim 3, wherein the protrusion units of the barrier ribs protrude into each of the discharge cells from the longitudinal barrier ribs.

5. The plasma display panel of claim 4, wherein the protrusion units of the barrier ribs comprise:
first protrusion units which protrude into the discharge cells from the longitudinal barrier ribs to correspond to the X electrodes; and
second protrusion units which protrude into the discharge cells from the longitudinal barrier ribs to correspond to the Y electrodes.

6. The plasma display panel of claim 3, wherein the horizontal cross sections of the protrusion units, viewed in a direction from the first substrate to the second substrate, are substantially rectangular.

7. The plasma display panel of claim 1, wherein the discharge units of the electrodes comprise:
first discharge units which protrude from the extension units toward the center of the discharge cells; and
second discharge units which further extend from the first discharge units toward the center of the discharge cells and have a width greater than the first discharge units.

8. The plasma display panel of claim 7, wherein the protrusion units of the barrier ribs comprise:
first protrusion units that protrude from the barrier ribs to correspond to the first discharge units of the X electrodes; and
second protrusion units that protrude from the barrier ribs to correspond to the first discharge units of the Y electrodes.

9. The plasma display panel of claim 8, wherein the interval between the first discharge units and the first protrusion units and between the first discharge units and the second protrusion units is about 60 to 80 μm.

10. The plasma display panel of claim 8, wherein the interval between the second discharge units and the barrier ribs is about 60 to 80 μm.

11. The plasma display panel of claim 1, wherein at least a portion of the first dielectric layer and at least a portion of the barrier ribs are colored with a pair of complementary colors.

12. The plasma display panel of claim 11, wherein at least a portion of the first dielectric layer is colored with a color comprising blue and at least a portion of the barrier ribs is colored with a color comprising brown.

13. The plasma display panel of claim 12, wherein the bus electrodes are disposed to correspond to a discharge space of the discharge cells.

14. The plasma display panel of claim 1, wherein the barrier ribs further define non-discharge cells within each of the discharge cells and the non-discharge cells have a volume smaller than the discharge cells.

15. The plasma display panel of claim 7, wherein the width of the first discharge units is determined by the interval between the first discharge units and the protrusion units.

16. The plasma display panel of claim 7, wherein the width of the second discharge units is determined by the interval between the second discharge units and the barrier ribs.

17. The plasma display panel of claim 3, wherein a portion of the fluorescent layers disposed on sidewalls of the longitudinal barrier ribs is thicker than other portions of the fluorescent layers, and the thickness of the fluorescent layers disposed on the sidewalls is about 30 to 50 μm.

18. The plasma display panel of claim 3, wherein the bus electrodes are disposed closer to a center of the discharge cells than the transverse barrier ribs.

19. A plasma display panel, comprising:
a first substrate;
a second substrate which faces the first substrate;
barrier ribs disposed between the first and second substrates that define discharge cells;
protrusion units to extend from the barrier ribs into the discharge cells; and
pairs of electrodes comprising extension units to extend across the first substrate and discharge units to extend from the extension units toward the center of each of the discharge cells,
wherein the discharge units are formed to correspond to the edges of the discharge cells as defined by the barrier ribs and are set apart therefrom by a predetermined distance.

20. The plasma display panel of claim 19, further comprising bus electrodes disposed on top of the barrier ribs.

21. The plasma display panel of claim 19, further comprising bus electrodes formed in the discharge cells and the bus electrodes including portions that are disposed on top of the barrier ribs.

22. A plasma display panel, comprising:
a first substrate;
a second substrate which faces the first substrate;
barrier ribs disposed between the first and second substrates that define discharge cells and comprise protrusion units protruding into the discharge cells; and
pairs of electrodes comprising extension units to extend across the first substrate and discharge units to extend from the extension units toward the center of each of the discharge cells,
wherein the protrusion units of the barrier ribs increase the internal surface area of the discharge cells.
